(19) United States
(12) Patent Application Publication
(10) Pub. No.: US 2012/0112858 A1
(43) Pub. Date: May 10, 2012

(54) ELECTROMAGNETIC CONTACT DEVICE

(75) Inventors: Kouetsu Takaya, Saitama (JP); Koji Okubo, Saitama (JP); Yasuhiro Naka, Saitama (JP); Toshikatsu Ohgami, Saitama (JP); Kenji Suzuki, Saitama (JP)

(73) Assignee: Fuji Electric Fa components & Systems Co., Ltd., Chuo-ku, Tokyo (JP)

(21) Appl. No.: 13/138,927

(22) PCT Filed: Jun. 14, 2010
(86) PCT No.: PCT/JP2010/003935

§ 371 Date: Jan. 4, 2012

(30) Foreign Application Priority Data
Aug. 20, 2009 (JP) 2009-190585

(51) Int. Cl. H01H 51/00

(52) U.S. Cl. 335/133

(57) ABSTRACT

A plurality of terminal chambers (20a) to (20e) is formed in a housing (16) by using a plurality of partition walls (24a) to (24e) to partition. In the terminal chambers, fixed contactors (31) each having a fixed contact point (31d) and a terminal screw (31a) are mounted. Engaged portions (31b) are formed integrally with the fixed contactors. Further, a press-fit engaging portion (26) is provided in each of the terminal chambers. The terminal chamber is formed as a space different from a space accommodating a movable contact point support, and the press-fit engaging portion is engaged by the engaged portion by press-fitting.

### TECHNICAL FIELD

The invention relates to an electromagnetic contact device, and more specifically relates to a structure for fixing a contactor device in a housing.

### BACKGROUND ART

In an electromagnetic contact device, an electromagnet is accommodated in a first case, and a contact point portion is accommodated in a second case which is stacked on and connected to this first case.

The second case includes a plurality of terminal chambers on the power supply side and a plurality of terminal chambers on the load side, which are mutually opposed on the rear-face side; and a movable contact point support of a contact point portion which moves by application of a voltage to the windings of the electromagnet is accommodated in the space between the power supply-side and the load-side terminal chambers. And, each terminal chamber accommodates a fixed contact point and a fixed contactor comprising a terminal screw (see for example Patent Reference 1).

Devices of the prior art similar to that of Patent Reference 1 are shown in FIG. 11 through FIG. 13.

FIG. 11 shows a fixed contactor 1 used in a device of the prior art. This fixed contactor 1 is provided with a fixed contact point 1c on a first bent piece 1b formed to be bent from one side of a terminal screw 1a; a boss hole 1e is formed in a second bent piece 1d formed to be bent from another side of the terminal screw 1a, and a press-fit claw 1f is formed on an end of the first contact piece 1b.

As shown in FIG. 12, in the second case 2, a plurality of terminal chambers 4a to 4d is formed by means of a plurality of partition walls 3a to 3d, separated and parallel; and bosses 6 are formed in outer walls perpendicularly intersecting the terminal bases 5 of these terminal chambers 4a to 4d. Here, as also shown in FIG. 13, the terminal chambers 4a to 4d communicate with an accommodation space 8 accommodating a movable contact point support 7. And, the fixed contactors 1 undergo an operation of dropping-in to the terminal chambers 4a to 4d, as indicated by the arrow with symbol A in FIG. 12, and an operation of pressing-in toward the accommodation space 8, as indicated by the arrow with symbol B. When pressing-in the fixed contactors 1, the press-fit claws 1f provided on an end of the first contact pieces 1b engage with recesses provided on the inner side after press-fitting into the terminal bases 5 (see FIG. 12), the bosses 6 mate with the boss holes 1e of the second contact pieces 1d and the fixed contactors 1 are installed, and the fixed contact points 1c of the fixed contactors 1 move up to the accommodation space 8 and oppose the movable contact points 9 arranged on the movable contact point support 7 (see FIG. 13).
Patent Reference 1: Japanese Patent Laid-open No. H6-310010

In the above-described second case 2, when a fixed contactor 1 is installed on a terminal base 5, the press-fit claw 1f of the fixed contactor 1 press-fitting onto the terminal base 5 shaves the surface of the terminal base 5, and shavings occur.

Here, the second case 2 communicates with the accommodation space 8 accommodating the terminal chambers 4a to 4d and the movable contact point support 8, so that if shavings enter into the accommodation space 8 which occur at the time of installation of a fixed contactor 1, there is the concern that a contact defect between a fixed contact point 1c and a movable contact point 9 may occur. Hence after installing the fixed contactor 1, air cleaning or similar is used to remove shavings. Hence in conventional installation of fixed contactors 1, a shaving-removal task is necessary, which is a problem from the standpoint of task efficiency.

### DISCLOSURE OF THE INVENTION

Further, in the second case 2, a boss 6 is formed as an escape prevention for the fixed contactor 1, and so there is a problem from the standpoint of manufacturing cost of the second case 2.

This invention has been made focusing on the above unresolved problems of examples of the prior art, and has as an object the provision of an electromagnetic contact device in which task efficiency can be improved and contact reliability of contact points can be enhanced by rendering the removal of shavings unnecessary even when shavings occur at the time of installation of a fixed contactor, and which enables reduced housing manufacturing costs.

In order to attain the above object, the electromagnetic contact device of one embodiment comprises a housing in which power supply-side terminals and load-side terminals are opposed to each other on a rear face side thereof, a movable contact point support is accommodated in a space between the terminals, a plurality of terminal chambers is formed by using a plurality of partition walls to partition, and fixed contactors each having a fixed contact point and a terminal screw are mounted as the terminals in the terminal chambers, wherein an engaged portion is formed integrally with each of the fixed contactors, and a press-fit engaging portion is formed in each of the terminal chambers as a space different from the space accommodating the movable, contact point support, and has the engage portion to be engaged by press-fitting.

By means of the electromagnetic contact device of this embodiment, a fixed contactor can be installed simply by press-fitting the engaged portion in one direction into the press-fit engaging portion formed in the terminal chambers, so that the number of installation processes is reduced.

Further, a press-fit engaging portion of a terminal chamber is formed as a space different from the space in which the movable contact point support is accommodated, so that an effect of shavings occurring upon press-fitting on the contact point on the movable contact point support side can be prevented.

Further, it is preferable that in the electromagnetic contact device of one embodiment, the press-fit engaging portion has an engaging wall forming a press-fit space of the engaged portion, and the engaged portion has an engaging tooth which is press-fit into the engaging wall.

By means of the electromagnetic contact device of this embodiment, the engaged portion of the fixed contactor is firmly press-fit into the press-fit engaging portion.

Further, in the electromagnetic contact device of one embodiment, a blocking portion for blocking the press-fit space, in which the engaged portion is press-fit into the press-fit engaging portion, may be provided in at least one of the engaged portion or the press-fit engaging portion.

By means of the electromagnetic contact device of this embodiment, shavings occur at the time of press-fitting of the engaging tooth of the engaged portion into the engaging wall of the press-fit engaging portion, but the shavings are sealed into the press-fit space by the blocking portion, so that removal of shavings by air cleaning or similar becomes unnecessary, and installation of the fixed contactor is made even easier.

Further, in the electromagnetic contact device of one embodiment, it is preferable that an escape-preventing portion, which prevents each of the fixed contactors in which the engaged portion is press-fit into the press-fit engaging portion from escaping in a direction opposite to a press-fitting direction, be provided.

By means of the electromagnetic contact device of this embodiment, escape of the fixed contactor can be reliably prevented, so that the reliability of the wiring terminal portion of the electromagnetic contact device is enhanced.

Further, in the electromagnetic contact device of one embodiment, it is preferable that a cover which blocks the space be installed on the housing, and a pressing portion, which abuts the terminal screw of each of the fixed contactors, and which functions as the escape-preventing portion, be provided on the cover.

By means of the electromagnetic contact device of this embodiment, a structure which prevents escape of the fixed contactor is obtained simply by installing a cover on a housing.

By means of the electromagnetic contact device of this invention, a fixed contactor is firmly mounted in a terminal chamber due to the pressing portion when the engaged portion is press-fitted into the press-fit engaging portion formed in the terminal chamber, so that escape of the fixed contactor can be reliably prevented even when a specialized portion for preventing escape is not formed in the housing.

Further, the press-fit engaging portion of a terminal chamber is formed as a space different from the space in which the movable contact point support is accommodated, so that an effect of shavings occurring upon press-fitting on the contact point on the movable contact point support side can be prevented, and the task of removing shavings and similar is rendered unnecessary, so that task efficiency is improved.

### BRIEF DESCRIPTION OF THE DRAWINGS

FIG. 1 is an exploded perspective view showing a lower case accommodating the electromagnet of an electromagnetic contact device and an upper case accommodating a contact point portion;

FIG. 2 is an exploded perspective view showing the structure of an upper case accommodating a contact point portion;

FIG. 3 shows the rear face shape of a cover mounted on an upper case;

FIG. 4 is an exploded perspective view showing the structure of an upper case accommodating a contact point portion from a direction different from that in FIG. 2;

FIG. 5 shows a state of mounting a fixed contactor in a terminal chamber of an upper case;

FIG. 6 shows principal portions of a terminal chamber in which is mounted a fixed contactor;

FIG. 7 shows the structure of a fixed contactor in one embodiment;

FIG. 8 shows a state in which a screw with a washer is screwed into a fixed contactor;

FIG. 9 shows the structure of the fixed contactor of an embodiment different from that of FIG. 7;

FIG. 10 shows a state in which the fixed contactor of FIG. 9 is mounted in a terminal chamber of an upper case;

FIG. 11 shows the structure of a fixed contactor of the prior art;

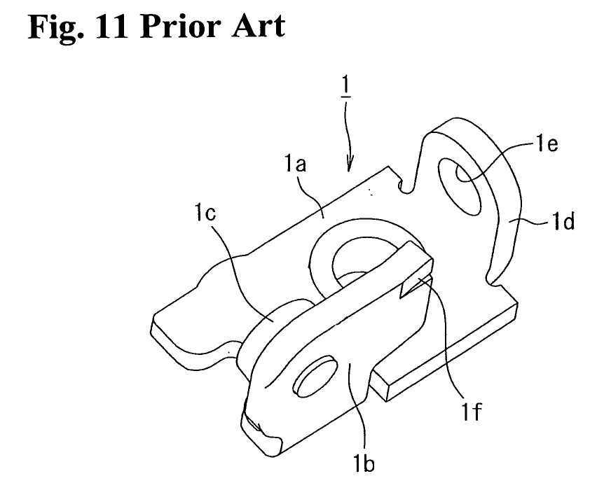

FIG. 12 shows the upper cover of an electromagnetic contact device using a fixed contactor of the prior art; and

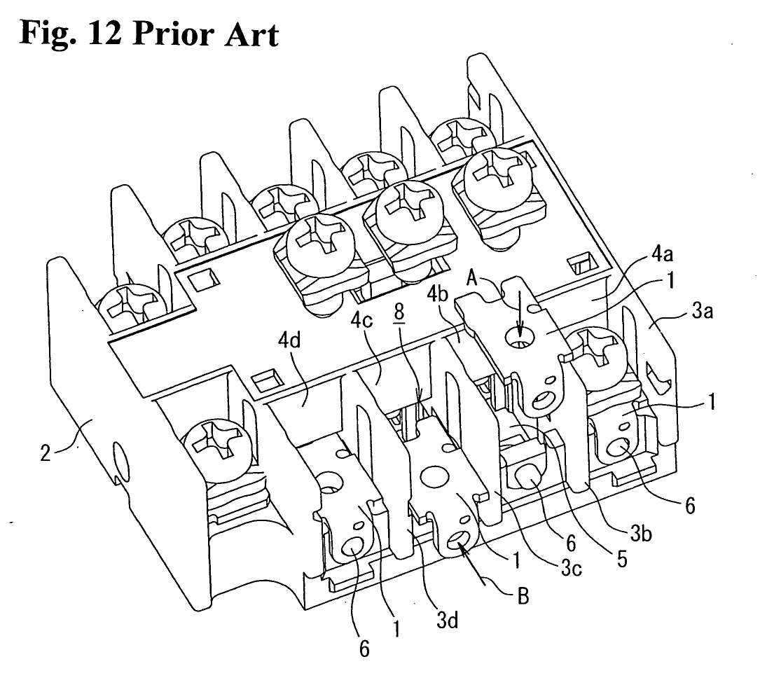

FIG. 13 shows the upper cover of an electromagnetic contact device using a fixed contactor of the prior art from a different direction.

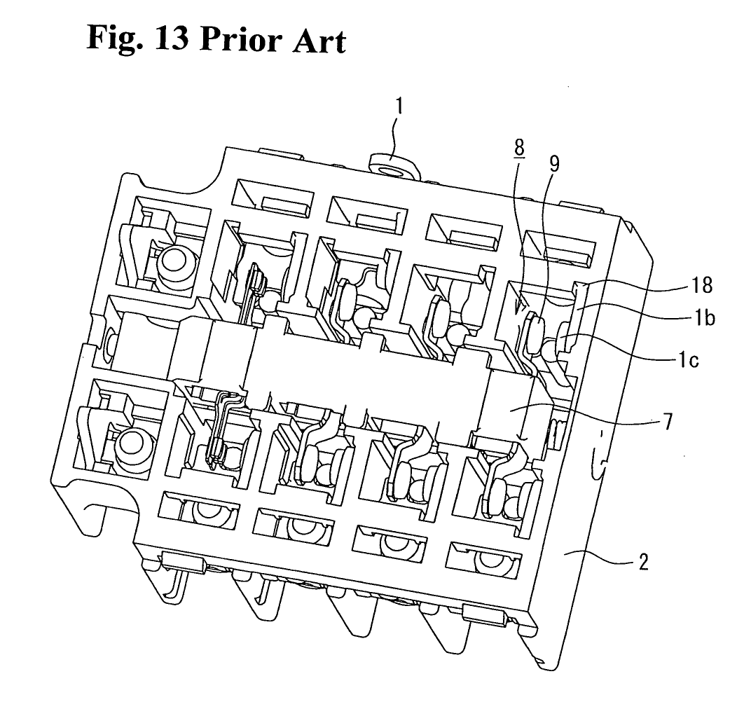

### BEST MODE FOR CARRYING OUT THE INVENTION

Below, preferred embodiments (hereafter “embodiments”) for implementing an electromagnetic contact device of the invention are explained in detail, referring to the drawings.

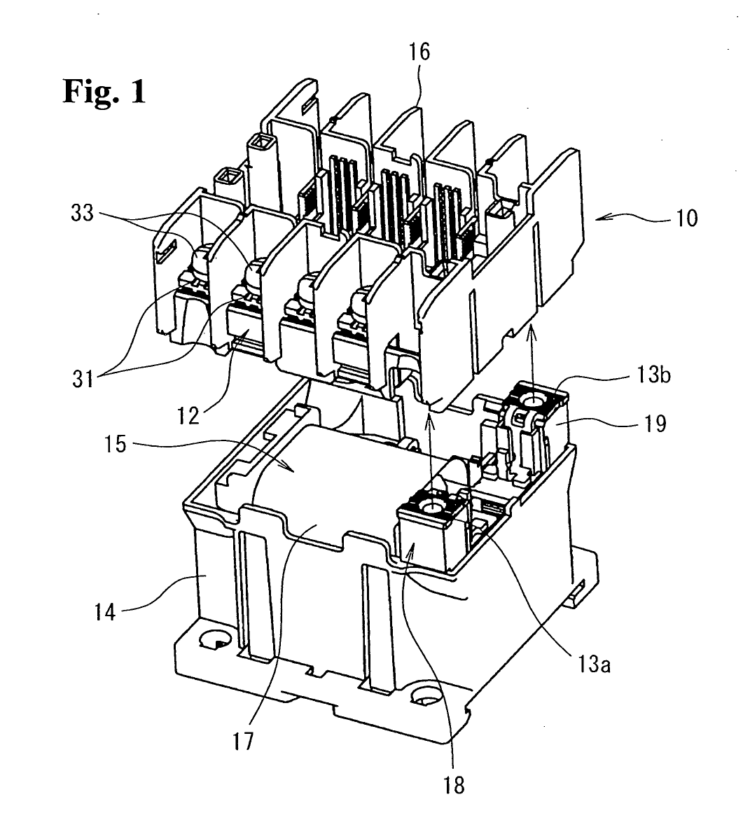

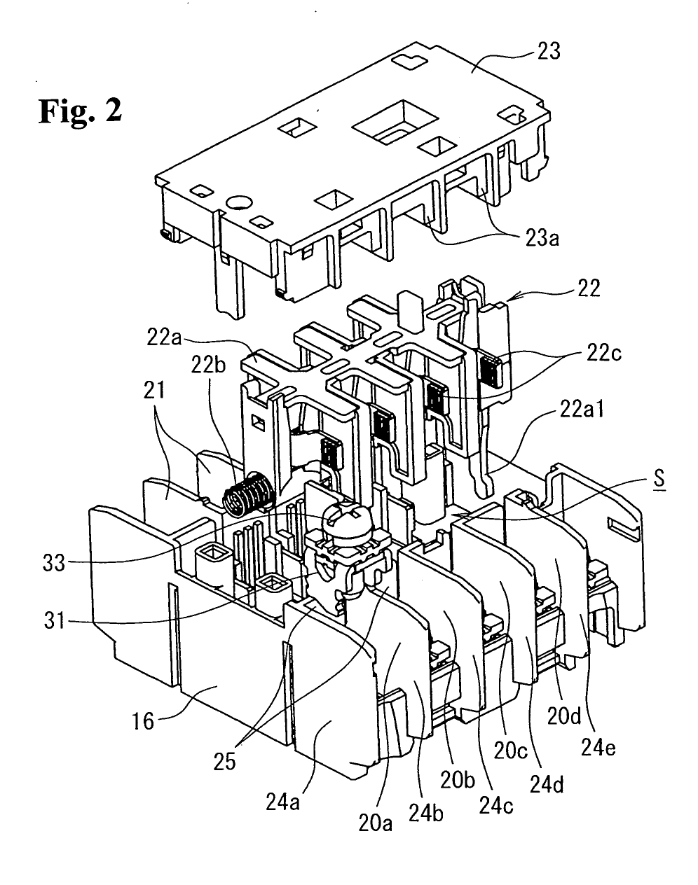

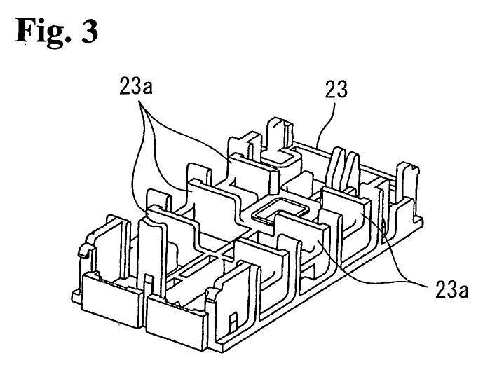

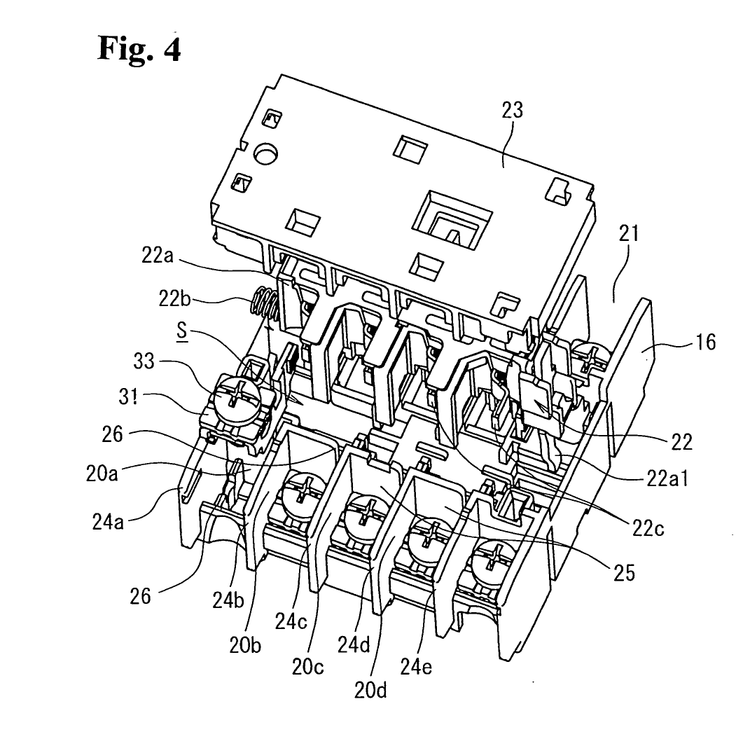

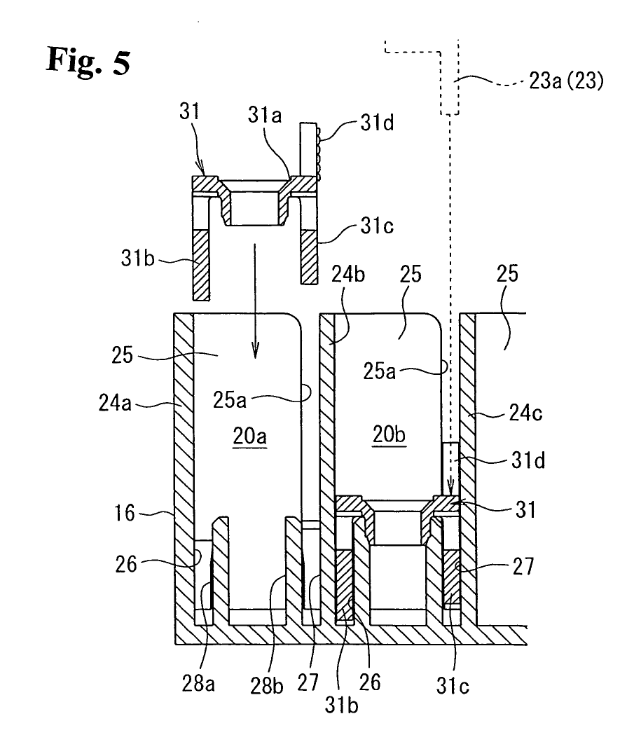

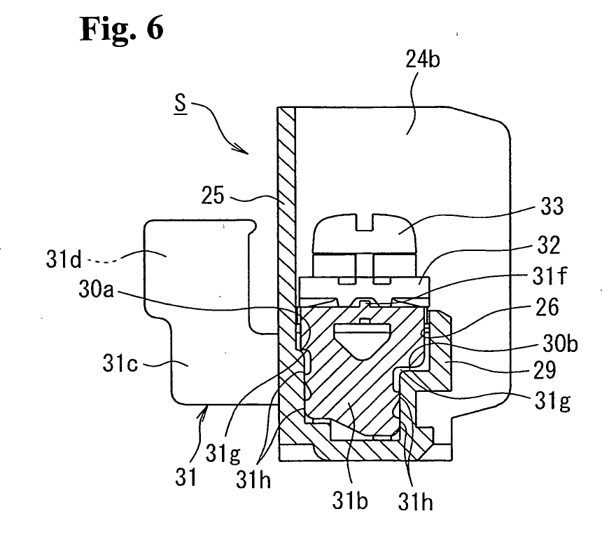

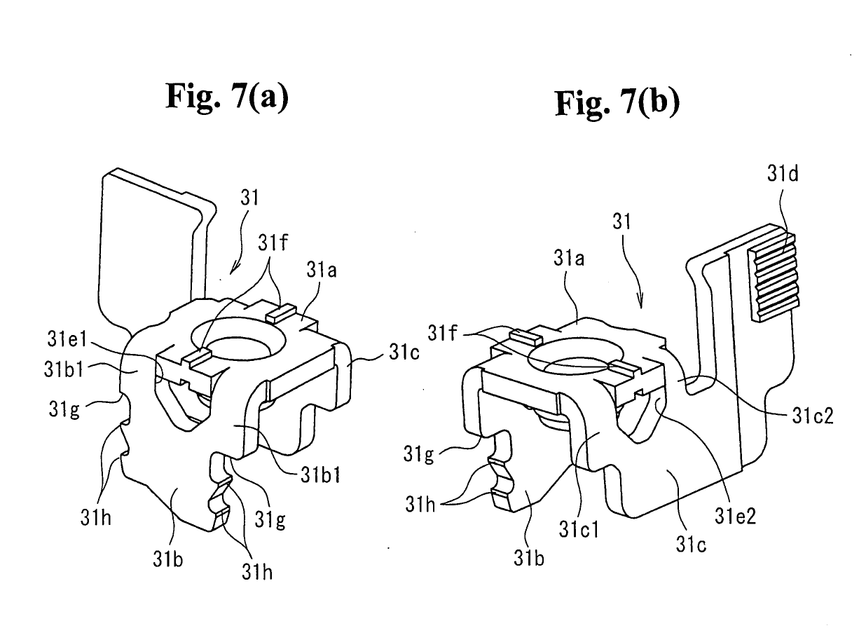

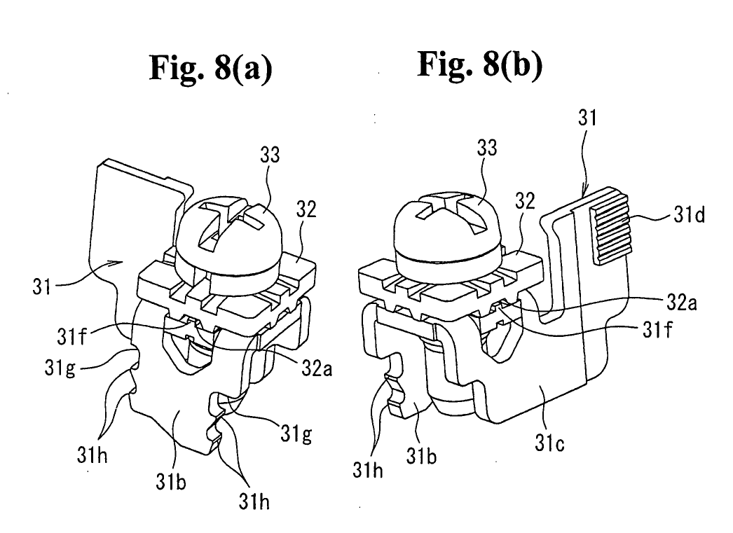

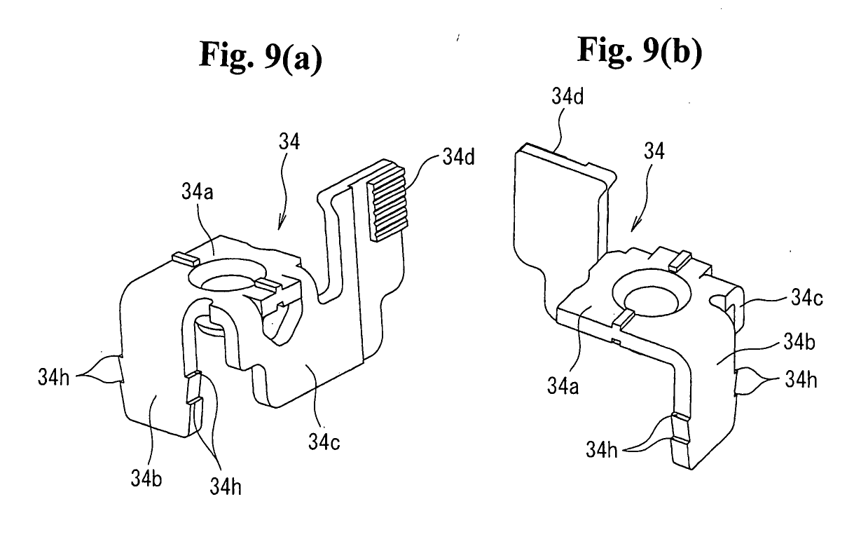

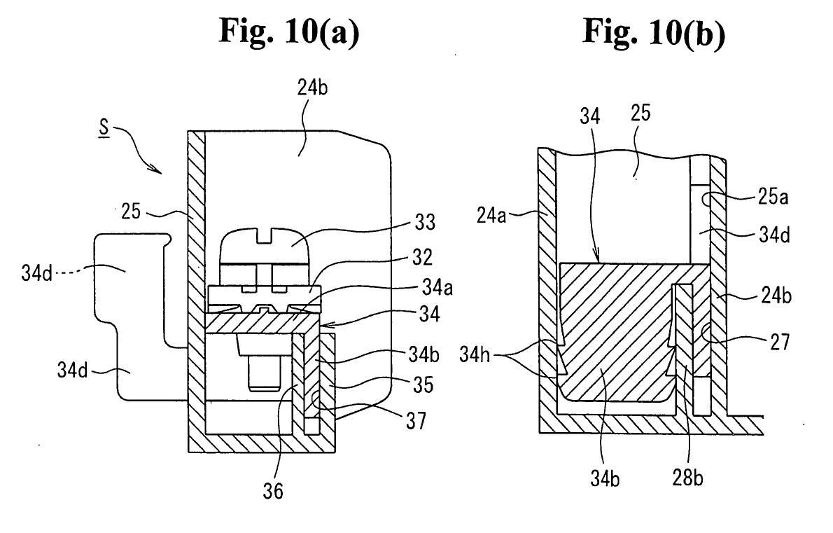

FIG. 1 is an exploded perspective view showing a lower case accommodating the electromagnet of an electromagnetic contact device and an upper case accommodating a contact point portion, FIG. 2 is an exploded perspective view showing the structure of an upper case accommodating a contact point portion, FIG. 3 shows the rear face shape of a cover mounted on an upper case, FIG. 4 is an exploded perspective view showing the structure of an upper case accommodating a contact point portion from a direction different from that in FIG. 2, FIG. 5 shows a state of mounting a fixed contactor in a terminal chamber of an upper case, FIG. 6 shows principal portions of a terminal chamber in which is mounted a fixed contactor, FIG. 7 shows the structure of a fixed contactor in one embodiment, FIG. 8 shows a state in which a screw with a washer is screwed into a fixed contactor, FIG. 9 shows the structure of the fixed contactor of an embodiment different from that of FIG. 7, and FIG. 10 shows a state in which the fixed contactor of FIG. 9 is mounted in a terminal chamber of an upper case.

As shown in FIG. 1, an electromagnetic contact device 10 of this embodiment is a device comprising terminal portions 12 each having contact points, and coil terminals 13a and 13b, and in which an electromagnet 15 is accommodated in a lower case 14 of a synthetic resin, and an upper case 16 of synthetic resin is mounted on an upper opening of the lower case 14. Terminal portions 12 each having contact points arranged on the front side of the upper case 16 in FIG. 1 are load-side terminals, and terminal portions (not shown) each having contact points are also arranged on the rear side of the upper case 16; these terminals are power supply-side terminals.

The electromagnet 15 comprises a coil frame (not shown) of synthetic resin, around which is wound an electromagnetic coil 17; a fixed core (not shown) fixed on a side wall of the lower case 14; a movable core (not shown), inserted into a hollow portion of the coil frame, opposing and enabling contact and separation with the fixed core; and a pair of coil terminal bases 18 and 19, separated and formed integrally on one end of the coil frame in which the movable core is arranged. Coil terminals 13a, 13b are respectively mounted on the pair of coil terminal bases 18, 19.

As shown in FIG. 2 to FIG. 4, in the upper case 16, a plurality of terminal chambers 20a to 20e on the load side and a plurality of terminal chambers 21 on the power supply side are provided in opposition on the rear face side; contact point portions 22 are accommodated in an accommodation space S provided between the load-side terminal chambers 20a to 20e and the power supply-side terminal chambers 21, and a cover 23 covering the accommodation space S is mounted on the upper case 16.

Here, as shown in FIG. 2 and FIG. 3, fixed contactor pressing portions 23a protruding toward the terminal chambers 20a to 20e are provided on the inside face of the cover 23.

A contact point portion 22 comprises a movable contact point support 22a of a synthetic resin, a return spring 22b, a plurality of movable contact points 22c, and a plurality of contact point springs (not shown). The movable contact point support 22a is arranged so as to move in parallel with the direction of motion of the movable core of the electromagnet 15, and a driving lever 22a1 provided on one side in the movement direction is linkably engaged with the movable core. The return spring 22b is arranged in the upper case 16 and acts with a spring urging force directed on one side of the movable contact point support 22a. The plurality of movable contact points 22c are arranged within the movable contact point support 22a and are each supported by a contact point spring (not shown), so as to enable movement in the same direction as the movable contact point support 22a. Further, the plurality of contact point springs are arranged so as to act with a spring urging force on each of the movable contact points 22c in the direction opposite the direction of action of the spring urging force of the return spring 22b.

Fixed contactors 31 are mounted in the load-side terminal chambers 20a to 20e as the above-described terminal portions 12, each having a contact point. The power supply-side terminal chambers and the fixed contactors mounted in these chambers have the same structure, so explanations are omitted.

The terminal chambers 20a to 20e are formed by using a plurality of first partition walls 24a to 24e to partition, in parallel and separated, as shown in FIG. 2 and FIG. 4; these terminal chambers 20a to 20e are provided in a space different from the accommodation space S by a second partition wall 25 formed to partition these from the accommodation space S.

As shown in FIG. 5, a press-fit space 26 and fixed contact point insertion space 27 are formed at positions in proximity to the first partition walls 24a, 24b in the terminal chamber 20a.

As shown in FIG. 5 and FIG. 6, the press-fit space 26 is a bursiform space enclosed by the first partition wall 24a, press-fit partition wall 28a rising up from the bottom face of the terminal chamber 20a, second partition wall 25, and front wall (wall opposing the second partition wall 25) 29, and open at the top. The second partition wall 25 and front wall 29 forming this press-fit space 26 are set so that the interval between partitions is narrow at the bottom and the interval between partitions broadens at the top, and as shown in FIG. 6, step faces 30a, 30b at places with different intervals between partitions are formed.

Further, the fixed contact point insertion space 27 is a space enclosed by the first partition wall 24b, press-fit partition wall 28b rising up from the bottom face of the terminal chamber 20a, second partition wall 25, and front wall 29, and communicates with the accommodation space S via a slit 25a formed in the second partition wall 25.

Further, in the other terminal chambers 20b to 20e, press-fit spaces 26 and fixed contact point insertion spaces 27 with the same structures as in the terminal chamber 20a are also formed.

As shown in FIG. 7, the fixed contactors 31 mounted in the terminal chambers 20a to 20e comprise a terminal screw 31a with a square shape in plane view, in which is formed a female screw hole; a press-fitted piece 31b formed by bending from one side of the terminal screw 31a; a bent piece 31c formed by bending from another side of the terminal screw 31a in the same direction as the press-fitted piece 31b; and a fixed contact point 31d formed at one end of the bent piece 31c.

The press-fitted piece 31b and bent piece 31c are made continuous with the terminal screw 31a via a pair of connecting rods 31b1, 31b2 and a pair of connecting rods 31c1, 31c2 by forming cutout openings 31e1, 31e2.

On the upper face of the terminal screw 31a is formed a wiring escape-preventing ridge 31f protruding in the radial direction.

Further, in the press-fitted piece 31b is provided a narrow portion 31g, the plate width dimension of which decreases suddenly from the pair of connecting rods 31b1, 31b2, and sawtooth-shape engaging teeth 31h are formed in the edge portion in the plate width direction, from this narrow portion 31g toward the end.

And, as shown in FIG. 8, a screw 33 with a washer 32 is screwed into the terminal screw 31a of this fixed contactor 31. Here, a groove 32a into which the wiring escape-preventing ridge 31f of the terminal screw 31a can enter is formed in the washer 32.

The press-fitted piece 31b and bent piece 31c of fixed contactors 31 with the above configuration are inserted into the press-fit spaces 26 and fixed contact point insertion spaces 27 of the terminal chambers 20a to 20e.

The sawtooth-shape engaging teeth 31h of the press-fitted pieces 31b are engaged while press-fitting with the inner faces of the second partition wall 25 and front wall 29, as shown in FIG. 6. At this time, the narrow portions 31g of the press-fitted pieces 31b oppose the step faces 30a, 30b formed in the press-fit space 26.

Further, when the bent piece 31c is inserted into the fixed contact point insertion space 27, one side of the bent piece 31c mates with the slit 25a, and the fixed contact point 31d formed on one end of the bent piece 31c is positioned in the accommodation space S, and is arranged opposing the front in the direction of motion of the plurality of movable contact points 22c of the contact point portion 22.

Further, as shown in FIG. 5, when the cover 23 is mounted on the upper case 16, the fixed contactor pressing portions 23a provided on the above-described cover 23 abut, from the upper face, the terminal screws 31a of the fixed contactors 31 mounted in the terminal chambers 20a to 20e.

And, when a voltage is applied to the electromagnetic coil 17 in the electromagnetic contact device 10 with the above configuration and the electromagnetic coil 17 is excited, the movable core moves toward the fixed core, the driving lever 22a1 moves together with motion of the movable core, and the movable contact point support 22a moves in the direction compressing the return spring 22b. When the movable contact point support 22a moves in the direction compressing the return spring 22b, the plurality of movable contact points 22c arranged on the movable contact point support 22a are pressed in contact with the fixed contact points 31d by the spring urging force of each contact point spring, and the plurality of movable contact points 22c and fixed contact points 31d enter the closed-path (ON) state.

Further, when excitation of the electromagnetic coil is stopped, the spring urging force of the return spring 22b presses the movable contact point support 22a and driving lever 22a1 to the original position, and the movable core also returns to the original position. And, when the movable contact point support 22a moves to the original position, the spring urging force of the plurality of contact point springs declines, and the plurality of movable contact points 22c and fixed contact points 31d enter the open-path (OFF) state.

The housing of this invention corresponds to the upper case 16, the terminals of this invention correspond to the terminal portions 12 each of which has a contact point, the partition walls of the invention correspond to the first partition walls 24a to 24e, the engaged portion of this invention corresponds to the press-fitted piece 31b, the press-fit engaging portion of this invention corresponds to the press-fit space 26, the engaging walls of this invention correspond to the second partition wall 25 and front wall 29, the space of this invention corresponds to the accommodation space S, the blocking portions of this invention correspond to the narrow portion 31g and step faces 30a and 30b, and the pressing portion of this invention corresponds to the fixed contactor pressing portions 23a.

By means of an electromagnetic contact device 10 with the above configuration, press-fitted pieces 31b of fixed contactors 31 are mounted by press-fitting into press-fit spaces 26 of the terminal chambers 20a to 20e formed in the upper case 16, but the engaging teeth 31h of the press-fitted piece 31b are engaged by press-fitting into the inner faces of the second partition wall 25 and front wall 29 forming the press-fit space 26. Hence escape of the fixed contactor 31 is prevented simply by press-fitting the fixed contactor 31 into the press-fit space 26, and mounting in the upper case 16 can be reliably performed.

Further, when the cover 23 is mounted on the upper case 16, the fixed contactor pressing portions 23a provided on the cover 23 abut the upper face of the terminal screws 31a of the fixed contactors 31 mounted in the terminal chambers 20a to 20e, so that escape of the fixed contactors 31 can be prevented even more reliably.

Here, when press-fitting the press-fit piece 31b of a fixed contactor 31 into a press-fit space 26, shavings occur due to press-fitting into the inner faces of the second partition wall 25 and front wall 29, but the narrow portion 31g of the press-fitted piece 31b opposes the step faces 30a, 30b formed in the press-fit space 26, and the shavings which occur are sealed within the press-fit space 26. Hence shavings do not intrude into contact point portions 22 or similar, and removal by air cleaning or similar is rendered unnecessary, so that tasks of installation of fixed contactors 31 can easily be performed, and the reliability of contact of the movable contact points 22c of the contact portion 22 and the fixed contact points 31d can be improved.

Further, a dedicated portion (boss or similar) for preventing escape of fixed contactors 31 is not formed in the upper case 16 of this embodiment, as in a device of the prior art, so that the manufacturing cost of the upper case 16 can be reduced.

Further, in this embodiment, fixed contactors 31 are continuous with the press-fitted pieces 31b and bent pieces 31c via cutout openings 31e1, 31e2 and with the terminal screws 31a, so that bending of the press-fitted pieces 31b and bent pieces 31c is easy, and a flat plate-shape terminal screw 31a can be formed.

Also, wiring escape-preventing ridges 31f are formed on the terminal screws 31a of the fixed contactors 31, so that when screwing screws 33 into terminal screws 31a and connecting external wiring, wiring can be performed reliably by clamping external wiring using washers 32, and external wiring connection tasks can easily be performed.

Next, FIG. 9 shows the structure of a fixed contactor in another embodiment, and FIG. 10 shows the structure of a terminal chamber in which the fixed contactor of another embodiment is mounted.

As shown in FIG. 9, the fixed contactor 34 of this embodiment comprises a terminal screw 34a with a square shape in plane view; a press-fitted piece 34b formed by bending from one side of the terminal screw 34a; a bent piece 34c formed by bending from another side of the terminal screw 34a and shifted 90° from the position of formation of the press-fitted piece 34b in the same direction as the press-fitted piece 34b; and a fixed contact point 34d formed at one end of the bent piece 34c.

Sawtooth-shape engaging teeth 34h are formed on an edge in the plate thickness direction of the press-fitted piece 34b.

Further, in this embodiment the terminal chamber 20a, a bursiform press-fit space 37 opening at the top is formed by the first partition wall 24a, front wall (wall opposing the second partition wall 25) 35, press-fit partition wall 36 in proximity to this front wall 35, and press-fit partition wall 28b in proximity to the first partition wall 24b. Further, a fixed contact point insertion space 27 is formed at a position in proximity to the first partition wall 24b of the terminal chamber.

In this embodiment, the press-fitted piece 34b and bent piece 34c of a fixed contactor 34 are inserted into a press-fit space 37 and fixed contact point insertion space 27 of a terminal chamber 20a.

As shown in FIG. 10(b), the sawtooth-shape engaging teeth 34h of the press-fitted piece 34b are engaged while press-fitting into the inner faces of the first partition wall 24a and press-fit partition wall 28b.

Further, when the bent piece 34c is inserted into the fixed contact point insertion space 27, one side of the bent piece 34c mates with the slit 25a, and the fixed contact point 34d formed on one end of the bent piece 34c is positioned in the accommodation space S, and is arranged opposing the front in the direction of motion of the plurality of movable contact points 22c of the contact point portion 22.

The engaged portion of this invention corresponds to the press-fitted piece 34b, the press-fit engaging portion of this invention corresponds to the press-fit space 37, and the engaging wall of this invention corresponds to the first partition wall 24a and the press-fit partition wall 28b.

By means of this embodiment, the press-fitted piece 34b of a fixed contactor 34 is press-fit into the press-fit space of a terminal chamber 20a and mounted, but the engaging teeth 34h of the press-fitted piece 34b are press-fit into the inner faces of the first partition wall 24a and press-fit partition wall 28b forming the press-fit space 37 while being engaged. Hence simply by press-fitting the fixed contactor 34 into the press-fit space 37, escape of the fixed contactor 34 is prevented, and reliable mounting on the upper case 16 can be performed.

### EXPLANATION OF REFERENCE NUMERALS

24a to 24e Partition wall
10 Electromagnetic contact device
12 Terminal portion
13a, 13b Coil terminal
14 Lower case
15 Electromagnet
16 Upper case
17 Electromagnetic coil
18, 19 Coil terminal base
20a to 20e Terminal chamber
22a Movable contact point support
22a1 Driving lever
22b Return spring
22c Movable contact point
23 Cover
23a Fixed contactor pressing portion
24a to 24e First partition wall
25 Second partition wall
25a Slit
26 Press-fit space
27 Fixed contact point insertion space
28a, 28b Press-fit partition wall
29 Front wall
30a, 30b Step face
31 Fixed contactor
31a Terminal screw
31b Press-fitted piece
31c Bent piece
31d Fixed contact point
31e1, 31e2 Cutout opening
31f Wiring escape-preventing ridge
31g Narrow portion
31h Engaging tooth
32 Washer
32a Groove
34 Fixed contactor
34b Press-fitted piece
34c Bent piece
34d Fixed contact point
34h Engaging tooth
35 Front wall
36 Press-fit partition wall
37 Press-fit space
S Accommodation space

1. An electromagnetic contact device, comprising a housing including power supply-side terminals and load-side terminals opposing to each other on a rear face side thereof, a movable contact point support accommodated in a space between the terminals thereof, a plurality of terminal chambers formed by a plurality of partition walls, and fixed contactors each having a fixed contact point and a terminal screw mounted as the terminal in the terminal chambers,
wherein an engaged portion is formed integrally with each of the fixed contactors, and
a press-fit engaging portion for engaging the engaged portion by press-fitting is arranged in each terminal chamber as a space different from the space accommodating the movable contact point support.

2. An electromagnetic contact device according to claim 1, wherein the press-fit engaging portion has an engaging wall forming a press-fit space of the engaged portion, and
the engaged portion has an engaging tooth for press-fitting into the engaging wall.

3. An electromagnetic contact device according to claim 2, wherein at least one of the engaged portion and the press-fit engaging portion has a blocking portion for blocking the press-fit space in which the engaged portion is press-fit into the press-fit engaging portion.

4. An electromagnetic contact device according to claim 1, further comprising an escape-preventing portion for preventing each of the fixed contactors, in which the engaged portion is press-fit into the press-fit engaging portion, from escaping in a direction opposite to a press-fitting direction.

5. An electromagnetic contact device according to claim 4, wherein the housing comprises a cover blocking the space, and said cover comprises a pressing portion abutting against the terminal screw of each of the fixed contactors and functioning as the escape-preventing portion.
